(19) United States
(12) Patent Application Publication
(10) Pub. No.: US 2025/0202819 A1
(43) Pub. Date: Jun. 19, 2025

(54) FLOW TABLE STORAGE METHOD AND APPARATUS, PACKET FORWARDING METHOD AND APPARATUS, COMPUTER DEVICE, AND MEDIUM

(71) Applicant: CLOUD INTELLIGENCE ASSETS HOLDING (SINGAPORE) PRIVATE LIMITED, Singapore (SG)

(72) Inventor: Shoujing BO, Hangzhou (CN)

(21) Appl. No.: 18/849,861

(22) PCT Filed: Mar. 15, 2023
(86) PCT No.: PCT/CN2023/081724

§ 371 Date: Sep. 23, 2024

(30) Foreign Application Priority Data
Mar. 23, 2022 (CN) 202210295137.9

(51) Int. Cl. H04L 45/7453

(52) U.S. Cl. CPC H04L 45/7453

(57) ABSTRACT

A flow table storage method and apparatus, a packet forwarding method and apparatus, a computer device, and a medium are disclosed. The flow table storage method includes: obtaining a keyword and data of a flow table to be stored; obtaining a first hash value and a second hash value of the keyword; storing the second hash value of the flow table to be stored in a first memory according to the first hash value; and storing the keyword and the data of the flow table to be stored in a second memory. In this way, more flow tables can be stored while ensuring that a bandwidth is satisfied, and due to address management of the flow table and the data of the flow table being separation, hash conflicts are reduced.

### CROSS-REFERENCE TO RELATED APPLICATIONS

The present application is a National Stage of International Application No. PCT/CN2023/081724, filed on Mar. 15, 2023, which claims priority to Chinese Patent Application No. 202210295137.9, filed with China National Intellectual Property Administration on Mar. 23, 2022 and entitled “FLOW TABLE STORAGE METHOD AND APPARATUS, PACKET FORWARDING METHOD AND APPARATUS, COMPUTER DEVICE, AND MEDIUM”. The contents of the two applications are hereby incorporated by reference in their entireties.

### TECHNICAL FIELD

One or more embodiments of the present application relate to the field of communication technology and, in particular, to a flow table storage method and apparatus, a packet forwarding method and apparatus, a computing device, and a medium.

### BACKGROUND

With the rapid development of cloud computing, the status of smart network card chips in cloud networks continues to rise, and the core of the smart network card chips lies in the effective management of flow tables. Increasing the number of forwarding flow tables is one of the most important means for managing the flow tables. Since a HASH algorithm is usually used to calculate addresses and the flow tables are stored in corresponding address space, when the number of the forwarding flow tables is increased, a difficult issue of address conflicts caused by the HASH algorithm is unavoidable. Therefore, how to reduce hash conflicts while storing as many the forwarding flow tables as possible is an urgent problem to be solved.

### SUMMARY

In view of this, one or more embodiments of the present specification provide a flow table storage method and apparatus, a packet forwarding method and apparatus, a computing device, and a medium.

To achieve the above objectives, one or more embodiments of the present specification provide following technical solutions:

According to a first aspect of one or more embodiments of the present specification, a flow table storage method is proposed, including:
obtaining a keyword and data of a flow table to be stored:
obtaining a first hash value and a second hash value of the keyword:
storing the second hash value of the flow table to be stored in a first memory according to the first hash value; and
storing the keyword and the data of the flow table to be stored in a second memory.

In some embodiments, the flow table to be stored has identification information, and the storing the second hash value of the flow table to be stored in the first memory according to the first hash value includes:
obtaining an address of a bucket corresponding to the flow table to be stored in the first memory according to the first hash value; and
storing the identification information and the second hash value of the flow table to be stored in a slot of the bucket.

In some embodiments, the storing the keyword and the data of the flow table to be stored in the second memory includes:
obtaining an address of a bucket corresponding to the flow table to be stored in the second memory according to the identification information of the flow table to be stored; and
storing the keyword and the data of the flow table to be stored in a slot of the bucket.

According to a second aspect of one or more embodiments of the present specification, a packet forwarding method is proposed, including:
obtaining a keyword of a packet to be forwarded, and obtaining a third hash value and a fourth hash value of the keyword:
obtaining a second hash value of a keyword of at least one flow table from a first memory according to the third hash value, and determining a flow table that matches the packet to be forwarded by comparing the fourth hash value with the second hash value of the keyword of the at least one flow table, where an address storing the second hash value in the first memory is determined according to a first hash value of a keyword of the flow table:
obtaining a keyword of a flow table that matches the packet to be forwarded from a second memory, where the second memory stores keywords and data of flow tables; and
performing a forwarding processing on the packet to be forwarded according to the data of the flow table in a case that the keyword of the flow table matches the keyword of the packet to be forwarded.

In some embodiments, the determining the flow table that matches the packet to be forwarded by comparing the fourth hash value with the second hash value of the keyword of the at least one flow table includes:
obtaining an address of a corresponding bucket in the first memory according to the second hash value of the packet to be forwarded; and
comparing second hash values of flow tables stored in each slot of the bucket with the fourth hash value of the packet to be forwarded, and determining a flow table having a same hash value as the flow table that matches the packet to be forwarded.

In some embodiments, each slot of the bucket further stores identification information of the flow tables, the obtaining the keyword of the flow table that matches the packet to be forwarded from the second memory includes:
obtaining identification information of the flow table that matches the packet to be forwarded:
obtaining an address of a corresponding bucket in the second memory according to the identification information:
obtaining the keyword and the data of the flow table stored in the bucket; and
performing the forwarding processing on the packet to be forwarded according to the data of the flow table in the case that the keyword of the flow table matches the keyword of the packet to be forwarded.

According to a third aspect of one or more embodiments of the present specification, a flow table storage apparatus is proposed, including:
a first obtaining unit, configured to obtain a keyword and data of a flow table to be stored:
a second obtaining unit, configured to obtain a first hash value and a second hash value of the keyword:
a first storing unit, configured to store the second hash value of the flow table to be stored in a first memory according to the first hash value; and
a second storing unit, configured to store the keyword and the data of the flow table to be stored in a second memory.

In some embodiments, the flow table to be stored has identification information, and the first storing unit is further configured to:
obtain an address of a bucket corresponding to the flow table to be stored in the first memory according to the first hash value; and
store the identification information and the second hash value of the flow table to be stored in a slot of the bucket.

In some embodiments, the second storing unit is further configured to:
obtain an address of a bucket corresponding to the flow table to be stored in the second memory according to the identification information of the flow table to be stored; and
store the keyword and the data of the flow table to be stored in a slot of the bucket.

According to a fourth aspect of one or more embodiments of the present specification, a packet forwarding apparatus is proposed, including:
a first obtaining unit, configured to obtain a keyword of a packet to be forwarded, and obtain a third hash value and a fourth hash value of the keyword:
a determining unit, configured to obtain a second hash value of a keyword of at least one flow table from a first memory according to the third hash value, and determine a flow table that matches the packet to be forwarded by comparing the fourth hash value with the second hash value of the keyword of the at least one flow table, where an address storing the second hash value in the first memory is determined according to a first hash value of a keyword of the flow table:
a second obtaining unit, configured to obtain a keyword of a flow table that matches the packet to be forwarded from a second memory, where the second memory stores keywords and data of flow tables; and
a forwarding unit, configured to perform a forwarding processing on the packet to be forwarded according to the data of the flow table in a case that the keyword of the flow table matches the keyword of the packet to be forwarded.

In some embodiments, the determining unit is further configured to:
obtain an address of a corresponding bucket in the first memory according to the second hash value of the packet to be forwarded; and
compare second hash values of flow tables stored in each slot of the bucket with the fourth hash value of the packet to be forwarded, and determine a flow table having a same hash value as the flow table that matches the packet to be forwarded.

In some embodiments, the forwarding unit is further configured to:
obtain identification information of the flow table that matches the packet to be forwarded:
obtain an address of a corresponding bucket in the second memory according to the identification information:
obtain the keyword and the data of the flow table stored in the bucket; and
perform the forwarding processing on the packet to be forwarded according to the data of the flow table in the case that the keyword of the flow table matches the keyword of the packet to be forwarded.

According to a fifth aspect of one or more embodiments of the present specification, a computing device is proposed, the computing device including:
a processor; and
a memory, configured to store processor-executable instructions:
where the processor executes the executable instructions to implement operations performed by the flow table storage method or packet forwarding method provided by any one of the above embodiments.

According to a sixth aspect of one or more embodiments of the present specification, a computer-readable storage medium is proposed, the computer-readable storage medium stores computer instructions thereon, when the computer instructions are executed by a processor, operations performed by the flow table storage method or packet forwarding method provided by any one of the above embodiments are implemented.

According to a seventh aspect of one or more embodiments of the present specification, a computer program product is proposed, where the computer program product includes a computer program, when the computer program is executed by a processor, operations performed by the flow table storage method or packet forwarding method provided by any one of the above embodiments are implemented.

The present application obtains the first hash value and the second hash value of the keyword of the flow table to be stored, stores the second hash value of the flow table to be stored in the first memory according to the first hash value, and stores the keyword and the data of the flow table to be stored in the second memory. In this way, more flow tables can be stored while ensuring that a bandwidth is satisfied, and due to address management of the flow table and the data of the flow table being separation, hash conflicts are reduced.

### BRIEF DESCRIPTION OF DRAWINGS

FIG. 1 is a schematic diagram of flow table storage in related art provided by an exemplary embodiment.

FIG. 2 is a flowchart of a flow table storage method provided by an exemplary embodiment.

FIG. 3 is a schematic diagram of flow table storage provided by an exemplary embodiment.

FIG. 4 is a flowchart of a packet forwarding method provided by an exemplary embodiment.

FIG. 5 is a block diagram of a flow table storage apparatus provided by an exemplary embodiment.

FIG. 6 is a block diagram of a packet forwarding apparatus provided by an exemplary embodiment.

FIG. 7 is a schematic structural diagram of a computing device provided by an exemplary embodiment.

### DESCRIPTION OF EMBODIMENTS

Exemplary embodiments will be described in detail here, examples of which are illustrated in the accompanying drawings. When the following description refers to the drawings, same number in different drawings refer to the same or similar element unless otherwise indicated. The implementations described in the following exemplary embodiments do not represent all implementations consistent with the present application. On the contrary, they are merely examples of devices and methods consistent with some aspects of the present application as detailed in the appended claims.

It should be noted that in other embodiments the steps of the corresponding method are not necessarily performed in the order shown and described in the present specification. In some other embodiments, the method thereof may comprise more or fewer steps than described in the present specification. In addition, a single step described in the present specification may be broken down and described as a plurality of steps in other embodiments. A plurality of steps described in the present specification may be combined and described as a single step in other embodiments.

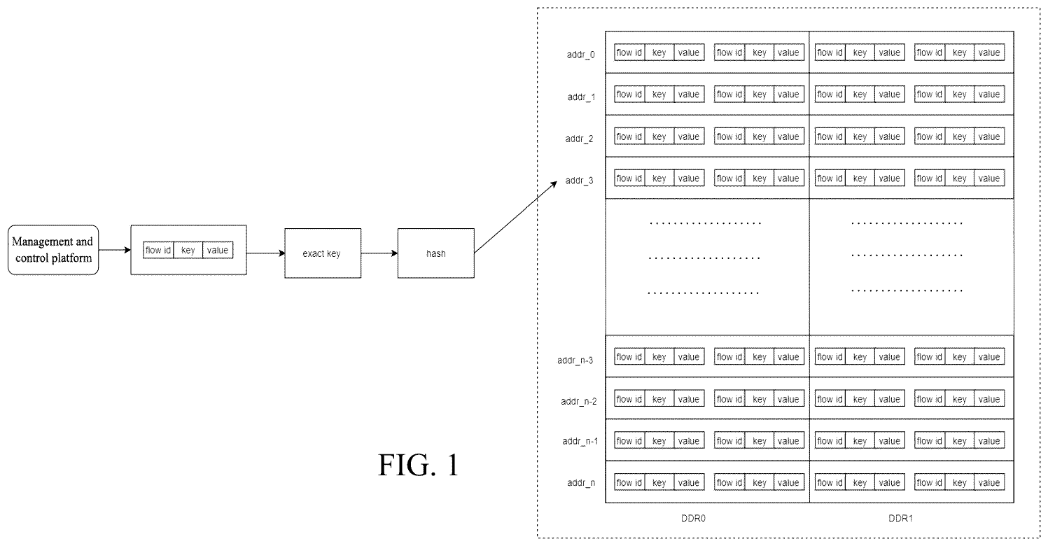

In related art, a method of storing a flow table or inserting a flow table is usually to merge address and data of the flow table. The following describes a flow table storage method commonly used in the related art in conjunction with FIG. 1.

A current intelligent network card system usually uses two dynamic random memories (DRAMs) to store the flow table, as shown in FIG. 1, memories DDR0 and DDR1 are utilized to store the flow table in the present embodiment. A flow table to be stored can be issued by a management and control platform, which usually includes identification information (ID, i.e. flow_id in FIG. 1), keyword (key), and data (value) of the flow table to be stored. First, the keyword is extracted from information of the flow table to be stored issued by the management and control platform (exact key), and a storage address of the flow table is determined according to a hash value of the key. In the present embodiment, the hash value of the key instructs an address addr_3, so that the ID, key, and data of the flow table are stored in a bucket with the address addr_3.

In the above scheme, assuming that each slot stores 64 Byte, two DRAMs can accommodate up to four slots. If the capacity of the flow table storage is expanded by adding a memory, not only is the hardware burden increased, but a hash conflict issue also occurs more easily.

In view of this, the present application provides a flow table storage method, which may be performed by a computer device, the computer device may be a server, such as one server, a plurality of servers, a cloud computing platform, etc. In an implementation, the computer device may be other types of devices, and the type of device of the computer device is not limited in the present application. Implementations of the present application are described below.

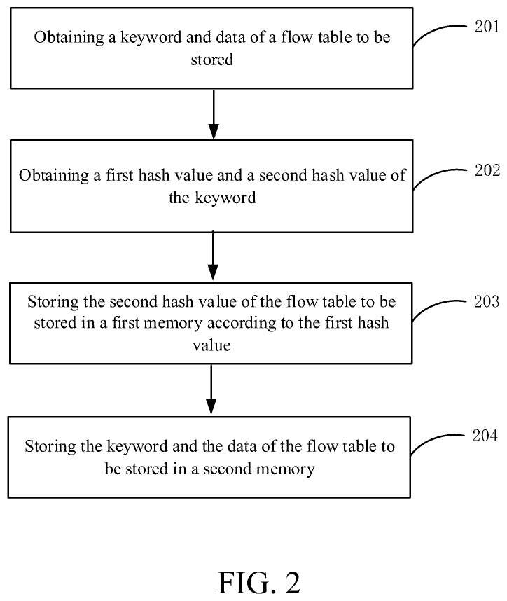

Referring to FIG. 2. FIG. 2 is a flowchart of a flow table storage method provided by an exemplary embodiment, the method includes the following steps.

Step 201: obtaining a keyword and data of a flow table to be stored.

The flow table to be stored may be issued by a management and control platform. Information issued by the management and control platform may include the keyword and the data of the flow table to be stored, and so on.

Step 202: obtaining a first hash value and a second hash value of the keyword.

In an embodiment, the keyword of the flow table to be stored can be processed by using hash function a to obtain the first hash value, and the process can be expressed as hasha(key1), where key1 represents the keyword of the flow table to be stored, and hasha represents the hash function a. At the same time, the keyword of the flow table to be stored can be processed by using hash function b to obtain the second hash value, and the process can be expressed as hashb(key1), where key1 represents the keyword of the flow table to be stored, and hashb represents the hash function b.

Step 203: storing the second hash value of the flow table to be stored in a first memory according to the first hash value.

In this step, the second hash value of the flow table to be stored can be stored at a corresponding position in the first memory according to address information indicated by the first hash value.

Step 204: storing the keyword and the data of the flow table to be stored in a second memory.

In the embodiment of the present disclosure, an address in the first memory indicated by the first hash value of the keyword of the flow table to be stored is used to store the second hash value of the keyword, and the keyword and the data of the flow table to be stored are stored in the second memory. By associating the second hash value stored in the first memory with an address for storing the keyword and the data in the second memory, flow table information items stored in the first memory and the second memory can be used together to process a packet to be forwarded. Since the second hash value is stored in the address indicated by the first hash value, an amount of data stored in the address corresponding to the first hash value is reduced compared to that for storing the keyword and the data. On the one hand, more flow tables can be stored. On the other hand, when the flow table is used for packet forwarding, one more match with the hash value can be added, thereby reducing probability of a hash conflict.

The present application obtains the first hash value and the second hash value of the keyword of the flow table to be stored, stores the second hash value of the flow table to be stored in the first memory according to the first hash value, and stores the keyword and the data of the flow table to be stored in the second memory. In this way, more flow tables can be stored while ensuring that a bandwidth is satisfied, and due to address management of the flow table and the data of the flow table being separation, hash conflicts are reduced.

The above is a description of a basic implementation process of the present application. Multiple implementations of the present application are described in following.

In an embodiment, the flow table to be stored has identification information (ID), and flow table items stored in the first memory can be associated with flow table items stored in the second memory according to the identification information.

Specifically, an address of a bucket corresponding to the flow table to be stored in the first memory can be obtained according to the first hash value, and the identification information and the second hash value of the flow table to be stored can be stored in a slot of the bucket.

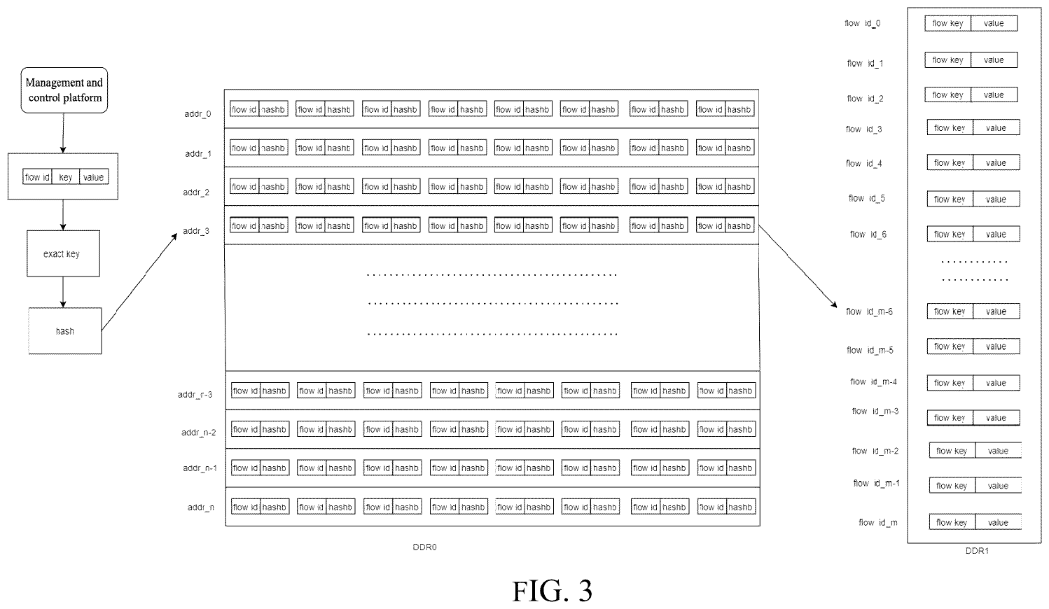

See a schematic diagram of flow table storage shown in FIG. 3. As shown in FIG. 3, according to the first hash value hasha(key), it is determined that an address corresponding to the flow table to be stored in a first memory DDR0 is addr_3, that is, a bucket with the address addr_3. Each bucket of the first memory has a plurality of slots, and ID (flow_id) of the flow table to be stored and the second hash value hashb(key) can be stored in a free slot of the bucket with address addr_3. Since an amount of data of the ID of the flow table to be stored and the hashb(key) is smaller than the keyword and the data, more slots can be set in the bucket of addr_3 to store the flow table items, thereby increasing the storage quantity of the flow table. Taking FIG. 3 as an example, when the amount of data of the ID of the flow table to be stored and the hashb(key) is 56 bits, each address (each bucket) of DDR0 can store 9) slots. Compared with the same configuration in the related art, the embodiment of the present disclosure increases the storage quantity of the flow table while ensuring the bandwidth.

In a case where the flow table to be stored has identification information (ID), the keyword and the data of the flow table can be stored by the following method: obtaining an address of a bucket corresponding to the flow table to be stored in the second memory according to the identification information of the flow table to be stored, and storing the keyword and the data of the flow table to be stored in a slot of the bucket. See the schematic diagram of flow table storage shown in FIG. 3. As shown in FIG. 3, according to the ID (flow_id) of the flow table to be stored, the address of the bucket where the flow table is to be stored in the second memory is obtained. Taking the ID of the flow table to be stored being m-6 as an example, the address of the bucket where the flow table is to be stored in the second memory indicated by the ID is flow_id_m-6, and the keyword and the data of the flow table to be stored are stored in a slot of the bucket with the address flow_id_m-6.

In the embodiment of the present disclosure, by utilizing the identification information of the flow table to be stored, a storage position of the flow table to be stored in the first memory is associated with a storage position of the flow table in the second memory, so that a normal processing of a packet to be forwarded can be achieved in the separation of the address management of the flow table from the storage of the data, which reduces the hash conflict.

The present application also provides a packet forwarding method, which performs a processing on a received packet to be forwarded based on a stored flow table carried out by a flow table storage method proposed in embodiments of the present disclosure. The above method can be applied to a packet forwarding apparatus, and the packet forwarding apparatus may be, for example, a computer device, such as a server, a plurality of servers, a cloud computing platform, etc. In an implementation, the computer device may be other types of devices, the type of device of the computer device is not limited in the present application. Implementations of the present application are described below:

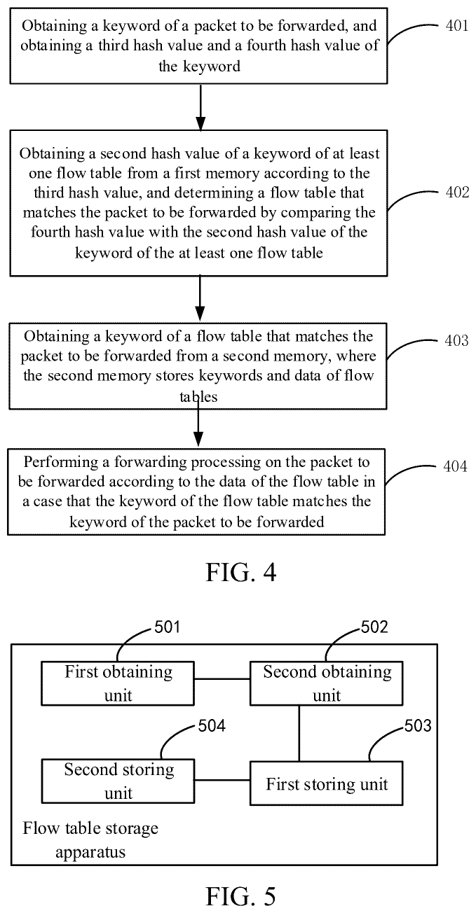

Referring to FIG. 4, FIG. 4 is a flowchart of a packet forwarding method provided by an exemplary embodiment, the method includes the following steps.

Step 401, obtaining a keyword of a packet to be forwarded, and obtaining a third hash value and a fourth hash value of the keyword.

In response to receiving a packet to be forwarded, a packet forwarding apparatus first obtains a keyword of the packet to be forwarded, and obtains a third hash value and a fourth hash value of the keyword.

In an embodiment, the keyword of the packet to be forwarded can be processed by using hash function a to obtain the third hash value, and the process can be expressed as hasha(key_m), where key_m represents the keyword of the packet to be forwarded and hasha represents hash function a. At the same time, the keyword of the packet to be forwarded can be processed by using hash function b to obtain the fourth hash value, and the process can be expressed as hashb(key_m), where hashb represents the hash function b.

Step 402, obtaining a second hash value of a keyword of at least one flow table from a first memory according to the third hash value, and determining a flow table that matches the packet to be forwarded by comparing the fourth hash value with the second hash value of the keyword of the at least one flow table.

An address storing the second hash value in the first memory is determined according to a first hash value of a keyword of the flow table.

In the embodiment of the present disclosure, the same hash processing is adopted for the keyword of the flow table and the keyword of the packet to be forwarded. That is, the first hash value and the second hash value of the keyword of the flow table are also obtained by processing the keyword of the flow table using hash function a and hash function b respectively.

After obtaining the third hash value of the keyword of the packet to be forwarded, an address indicated by the third hash value in the first memory is determined, so that at least one flow table item stored in the address is obtained, that is, the second hash value of the keyword of the at least one flow table. By comparing the fourth hash value of the keyword of the packet to be forwarded with the second hash value of the keyword of the at least one flow table, a flow table having the same hash value as the fourth hash value is determined as a matched flow table.

Step 403, obtaining a keyword of a flow table that matches the packet to be forwarded from a second memory, where the second memory stores keywords and data of flow tables.

Step 404, performing a forwarding processing on the packet to be forwarded according to the data of the flow table in a case that the keyword of the flow table matches the keyword of the packet to be forwarded.

After obtaining the keyword of the matching flow table, the keyword of the flow table is compared with the keyword of the packet to be forwarded. When the keyword of the flow table is the same as the keyword of the packet to be forwarded, a match is confirmed, the data of the matching flow table is read, and the packet to be forwarded is forwarded according to an action indicated by the data.

In the embodiment of the present disclosure, for a packet to be forwarded, an address in the first memory indicted according to a third hash value of the keyword of the packet to be forwarded is first determined, a second hash value of the keyword of at least one flow table stored in the address is read, and a matched flow table is determined based on a matching result between the fourth hash value of the packet to be forwarded and the second hash value of each flow table, then, a keyword of the matched flow table is read in a second memory, and when the keyword of the flow table matches the keyword of the packet to be forwarded, data of the matched flow table is read to perform a forwarding processing on the packet to be forwarded. By increasing matching between the second hash value of the flow table and the fourth hash value of the packet to be forwarded, probability of a hash conflict is reduced and a quality of packet forwarding is improved.

The above is a description of a basic implementation process of packet forwarding of the present application. Multiple implementations of the present application are described in following.

In one example, the flow table that matches the packet to be forwarded is determined according to the following method: obtaining an address of a corresponding bucket in the first memory according to the second hash value of the packet to be forwarded: comparing second hash values of flow tables stored in each slot of the bucket with the fourth hash value of the packet to be forwarded, and determining a flow table having a same hash value as the flow table that matches the packet to be forwarded.

In one example, each slot of the bucket further stores identification information of the flow tables, the obtaining the keyword of the flow table that matches the packet to be forwarded from the second memory includes: obtaining identification information of the flow table that matches the packet to be forwarded: obtaining an address of a corresponding bucket in the second memory according to the identification information: obtaining the keyword and the data of the flow table stored in the bucket; and performing the forwarding processing on the packet to be forwarded according to the data of the flow table in the case that the keyword of the flow table matches the keyword of the packet to be forwarded.

The following is a detailed description of the packet forwarding method proposed in the present application, taking as an example that the packet forwarding apparatus performing packet forwarding using a flow table obtained by storing the flow table using a flow table storage method shown in FIG. 3.

As shown in FIG. 3, a bucket corresponding to each address of the first memory DDR0 has a plurality of slots therein, each slot stores ID (flow_id) of the flow table and the second hash value hashb(key) of the keyword (key) of the flow table, and each address of the flow table corresponds to the first hash value hasha(key) of the keyword (key) of the flow table. Each address of a second memory DDR1 corresponds to the ID of the flow table, and the keyword (key) and data (value) of the flow table are stored in a bucket corresponding to each address.

When a packet to be forwarded is received and texture information key_m of the packet to be forwarded is obtained, a third hash value hasha(key_m) and a fourth hash value hashb(key_m) of the texture information key_m are firstly obtained.

Next, an address of a corresponding bucket in the first memory DDR0 is determined according to the third hash value hasha(key_m), for example, the address is addr_3, the second hash value hashb(key) of each flow table stored in the bucket corresponding to addr_3 is extracted. The fourth hash value hashb(key_m) of the packet to be forwarded is compared with the second hash value hashb(key) of each flow table above, and a flow table having a same hash value is used as a flow table that matches the packet to be forwarded.

After the matched flow table is determined, ID of the flow table can be obtained, and the ID can be utilized to obtain flow table items stored in the second memory DDR1. Taking the ID of the flow table matching the packet to be forwarded being m-6 as an example, a corresponding address in the second memory DDR1 corresponding to the ID of the flow table is determined as flow_id_m-6, and keywords and data of flow tables with the ID of m-6 stored in a bucket of that address is obtained, the keyword of the packet to be forwarded is compared with the keywords of the flow tables with the obtained ID of m-6, in a case where the keywords are the same, i.e., match, a corresponding forwarding process is performed on the packet to be forwarded on the basis of the data corresponding to the keyword.

Referring to FIG. 5, FIG. 5 is a block diagram of a flow table storage apparatus provided by an exemplary embodiment, the apparatus includes:
a first obtaining unit 501, configured to obtain a keyword and data of a flow table to be stored:
a second obtaining unit 502, configured to obtain a first hash value and a second hash value of the keyword:
a first storing unit 503, configured to store the second hash value of the flow table to be stored in a first memory according to the first hash value; and
a second storing unit 504, configured to store the keyword and the data of the flow table to be stored in a second memory.
In some embodiments, the flow table to be stored has identification information, and the first storing unit is further configured to:
obtain an address of a bucket corresponding to the flow table to be stored in the first memory according to the first hash value; and
store the identification information and the second hash value of the flow table to be stored in a slot of the bucket.

In some embodiments, the second storing unit is further configured to:
obtain an address of a bucket corresponding to the flow table to be stored in the second memory according to the identification information of the flow table to be stored; and
store the keyword and the data of the flow table to be stored in a slot of the bucket.

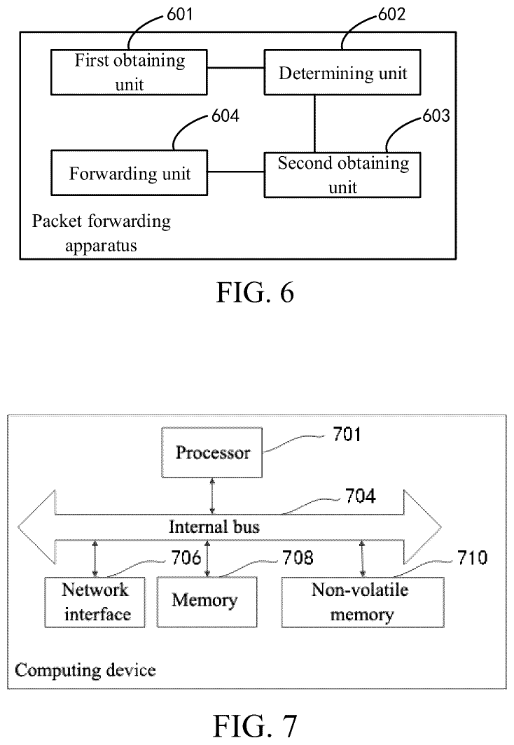

Referring to FIG. 6, FIG. 6 is a block diagram of a packet forwarding apparatus provided by an exemplary embodiment, the apparatus includes:
a first obtaining unit 601, configured to obtain a keyword of a packet to be forwarded, and obtain a third hash value and a fourth hash value of the keyword:
a determining unit 602, configured to obtain a second hash value of a keyword of at least one flow table from a first memory according to the third hash value, and determine a flow table that matches the packet to be forwarded by comparing the fourth hash value with the second hash value of the keyword of the at least one flow table, where an address storing the second hash value in the first memory is determined according to a first hash value of a keyword of the flow table:
a second obtaining unit 603, configured to obtain a keyword of a flow table that matches the packet to be forwarded from a second memory, where the second memory stores keywords and data of flow tables; and
a forwarding unit 604, configured to perform a forwarding processing on the packet to be forwarded according to the data of the flow table in a case that the keyword of the flow table matches the keyword of the packet to be forwarded.

In some embodiments, the determining unit is further configured to:
obtain an address of a corresponding bucket in the first memory according to the second hash value of the packet to be forwarded; and
compare second hash values of flow tables stored in each slot of the bucket with the fourth hash value of the packet to be forwarded, and determine a flow table having a same hash value as the flow table that matches the packet to be forwarded.

In some embodiments, the forwarding unit is further configured to:
obtain identification information of the flow table that matches the packet to be forwarded:
obtain an address of a corresponding bucket in the second memory according to the identification information;
obtain the keyword and the data of the flow table stored in the bucket; and
perform the forwarding processing on the packet to be forwarded according to the data of the flow table in the case that the keyword of the flow table matches the keyword of the packet to be forwarded.

For the apparatus embodiments, since they correspond essentially to the method embodiments, it is sufficient to refer to a portion of the description of the method embodiments where relevant. The apparatus embodiments described above are merely schematic, where the units described as illustrated as separated components may or may not be physically separated, and the components displayed as units may or may not be physical units, i.e., they may be located in one place or distributed over multiple network modules. Some or all of these units may be selected to fulfill the objectives of the present specification scheme according to actual needs. It can be understood and implemented by a person of ordinary skill in the art without creative labor.

The present application also provides a computing device. Referring to FIG. 7. FIG. 7 is a schematic structural diagram of a computing device provided by an exemplary embodiment. Please refer to FIG. 7, at a hardware level, the device includes a processor 701, an internal bus 704, a network interface 706, a memory 708, and a non-volatile memory 710. Of course, it may also include hardware required to implement other functions. One or more embodiments of the present specification may be implemented based on software, for example, the processor 701 reads a corresponding computer program from the non-transitory memory 710 into the memory 708 and then runs it. Of course, in addition to software implementation, one or more embodiments of the present specification do not exclude other implementation methods, such as a logic device or a combination of software and hardware, etc. That is to say, an executing entity of the following processing flow is not limited to each logic unit, but can also be hardware or the logic device.

The present application also provides a computer program product, where the computer program product includes a computer program, when the computer program is executed by a processor, the flow table storage method or the packet forwarding method provided by any one of the embodiments of the present application is implemented.

The systems, apparatuses, modules or units described in the above embodiments may be implemented by computer chips or entities, or by products with certain functions. A typical implementation device is a computer, which may be in the form of a personal computer, a laptop computer, a cellular phone, a camera phone, a smart phone, a personal digital assistant, a media player, a navigation device, an email sending and receiving device, a game console, a tablet computer, a wearable device, or a combination of any several of these devices.

In a typical configuration, a computer includes one or more processors (Central Processing Unit, CPU), an input/output interface, a network interface and a memory.

The memory may include a non-permanent memory in a computer-readable medium, a random access memory (RAM) and/or a non-volatile memory such as a read-only memory (ROM) or a flash RAM (flash RAM).

The computer-readable medium includes both permanent and non-permanent, removable and non-removable medium that may be implemented by any method or technology for storage of information. The information may be computer-readable instructions, data structures, program modules or other data. Examples of computer storage medium include, but are not limited to, a Phase-change Random Access Memory (PRAM), a Static Random-Access Memory (SRAM), a Dynamic Random Access Memory (DRAM), other types of Random Access Memory (RAM), Read-Only Memory, ROM), Electrically Erasable Programmable Read Only Memory (EEPROM), flash memory or other memory technology, Compact Disc Read Only Memory (CD-ROM), Digital Video Disc (DVD) or other optical storage, magnetic cassettes, magnetic disk storage, quantum memory, graphene-based storage medium or other magnetic storage devices, or any other non-transmission medium that can be used to store information that can be accessed by a computing device. According to the definition in the present article, the computer-readable medium does not include a temporary computer-readable media (Transitory Media), such as modulated data signals and carrier waves.

It should also be noted that the terms “comprise”, “include” or any other variations thereof are intended to cover non-exclusive inclusion, such that a process, method, commodity, or apparatus that includes a series of elements includes not only those elements, but also other elements not explicitly listed, or also includes elements inherent to such process, method, commodity, or apparatus. Without more constraints, an element defined by the phrase “comprising a . . . ” does not exclude the existence of other identical elements in the process, method, product or apparatus comprising the element.

Specific embodiments of the present application have been described above. Other embodiments are within the scope of the appended claims. In some cases, the actions or steps recited in the claims can be performed in a different order than in the embodiments and still achieve desirable results. Additionally, the processes depicted in the accompanying drawings do not necessarily require the specific order as shown, or sequential order, to achieve the desirable results. In some implementations, multitasking and parallel processing are also possible or may be advantageous.

The terms used in one or more embodiments of the present specification are for the objective of describing specific embodiments only and are not intended to limit the one or more embodiments of the present specification. As used in one or more embodiments of the present specification and the appended claims, the singular forms “a”, “an”, “the” and “this” are intended to include the plural forms as well, unless the context clearly indicates otherwise. It should also be understood that the term “and/or” as used herein refers to and encompasses any and all possible combinations of one or more of the associated listed items.

It should be understood that although the terms first, second, third, etc. may be used to describe various information in one or more embodiments of the present specification, the information should not be limited to these terms. These terms are used only to distinguish information of the same type from one another. For example, without departing from the scope of one or more embodiments of the present specification, first information may also be referred to as second information, and similarly, second information may also be referred to as first information. The word “if” as used herein may be interpreted as “at the time of . . . ” or “when the . . . ” or “in response to determining” depending on the context.

The above are only preferred embodiments of one or more embodiments of the present application, and are not intended to limit one or more embodiments of the present application. Any modifications, equivalent substitutions, improvements, etc. have been done within the spirit and principles of one or more embodiments of the present application should be included in the scope of protection of one or more embodiments of the present application.

1. A flow table storage method, comprising:
obtaining a keyword and data of a flow table to be stored;
obtaining a first hash value and a second hash value of the keyword;
storing the second hash value of the flow table to be stored in a first memory according to the first hash value; and
storing the keyword and the data of the flow table to be stored in a second memory.

2. The method according to claim 1, wherein the flow table to be stored has identification information, and the storing the second hash value of the flow table to be stored in the first memory according to the first hash value comprises:
obtaining an address of a bucket corresponding to the flow table to be stored in the first memory according to the first hash value; and
storing the identification information and the second hash value of the flow table to be stored in a slot of the bucket.

3. The method according to claim 2, wherein the storing the keyword and the data of the flow table to be stored in the second memory comprises:
obtaining an address of a bucket corresponding to the flow table to be stored in the second memory according to the identification information of the flow table to be stored; and
storing the keyword and the data of the flow table to be stored in a slot of the bucket.

4. A packet forwarding method, comprising:
obtaining a keyword of a packet to be forwarded, and obtaining a third hash value and a fourth hash value of the keyword;
obtaining a second hash value of a keyword of at least one flow table from a first memory according to the third hash value, and determining a flow table that matches the packet to be forwarded by comparing the fourth hash value with the second hash value of the keyword of the at least one flow table, wherein an address storing the second hash value in the first memory is determined according to a first hash value of a keyword of the flow table;
obtaining a keyword of a flow table that matches the packet to be forwarded from a second memory, wherein the second memory stores keywords and data of flow tables; and
performing a forwarding processing on the packet to be forwarded according to the data of the flow table in a case that the keyword of the flow table matches the keyword of the packet to be forwarded.

5. The method according to claim 4, wherein the determining the flow table that matches the packet to be forwarded by comparing the fourth hash value with the second hash value of the keyword of the at least one flow table comprises:
obtaining an address of a corresponding bucket in the first memory according to the second hash value of the packet to be forwarded; and
comparing second hash values of flow tables stored in each slot of the bucket with the fourth hash value of the packet to be forwarded, and determining a flow table having a same hash value as the flow table that matches the packet to be forwarded.

6. The method according to claim 5, wherein each slot of the bucket further stores identification information of the flow tables, the obtaining the keyword of the flow table that matches the packet to be forwarded from the second memory comprises:
obtaining identification information of the flow table that matches the packet to be forwarded;
obtaining an address of a corresponding bucket in the second memory according to the identification information;
obtaining the keyword and the data of the flow table stored in the bucket; and
performing the forwarding processing on the packet to be forwarded according to the data of the flow table in the case that the keyword of the flow table matches the keyword of the packet to be forwarded.

7-8. (canceled)

9. A computing device, comprising:
a processor; and
a memory, configured to store processor-executable instructions;
wherein the processor, when executing the executable instructions, is configured to:
obtain a keyword and data of a flow table to be stored;
obtain a first hash value and a second hash value of the keyword;
store the second hash value of the flow table to be stored in a first memory according to the first hash value; and
storing the keyword and the data of the flow table to be stored in a second memory.

10. A non-transitory computer-readable storage medium storing computer instructions thereon, wherein when the computer instructions are executed by a processor, the method according to claim 1.

11. The computing device according to claim 9, wherein the flow table to be stored has identification information, and the processor is configured to:
obtain an address of a bucket corresponding to the flow table to be stored in the first memory according to the first hash value; and
store the identification information and the second hash value of the flow table to be stored in a slot of the bucket.

12. The computing device according to claim 11, wherein the processor is configured to:
obtain an address of a bucket corresponding to the flow table to be stored in the second memory according to the identification information of the flow table to be stored; and
store the keyword and the data of the flow table to be stored in a slot of the bucket.

13. A computing device, comprising:
a processor; and
a memory, configured to store processor-executable instructions;
wherein the processor executes the executable instructions to implement the method according to claim 4.

14. The computing device according to claim 13, wherein the processor is configured to:
obtain an address of a corresponding bucket in the first memory according to the second hash value of the packet to be forwarded; and
compare second hash values of flow tables stored in each slot of the bucket with the fourth hash value of the packet to be forwarded, and determine a flow table having a same hash value as the flow table that matches the packet to be forwarded.

15. The computing device according to claim 14, wherein each slot of the bucket further stores identification information of the flow tables, and the processor is configured to:
obtain identification information of the flow table that matches the packet to be forwarded;
obtain an address of a corresponding bucket in the second memory according to the identification information;
obtain the keyword and the data of the flow table stored in the bucket; and
perform the forwarding processing on the packet to be forwarded according to the data of the flow table in the case that the keyword of the flow table matches the keyword of the packet to be forwarded.

16. The non-transitory computer-readable storage medium according to claim 10, wherein the flow table to be stored has identification information, and the processor is configured to perform the following operations:
obtaining an address of a bucket corresponding to the flow table to be stored in the first memory according to the first hash value; and
storing the identification information and the second hash value of the flow table to be stored in a slot of the bucket.

17. The non-transitory computer-readable storage medium according to claim 16, wherein the processor is configured to perform the following operations:
obtaining an address of a bucket corresponding to the flow table to be stored in the second memory according to the identification information of the flow table to be stored; and
storing the keyword and the data of the flow table to be stored in a slot of the bucket.

18. A non-transitory computer-readable storage medium storing computer instructions thereon, wherein when the computer instructions are executed by a processor, the method according to claim 4.

19. The non-transitory computer-readable storage medium according to claim 18, wherein the processor is configured to perform the following operations:
obtaining an address of a corresponding bucket in the first memory according to the second hash value of the packet to be forwarded; and
comparing second hash values of flow tables stored in each slot of the bucket with the fourth hash value of the packet to be forwarded, and determining a flow table having a same hash value as the flow table that matches the packet to be forwarded.

20. The non-transitory computer-readable storage medium according to claim 19, wherein each slot of the bucket further stores identification information of the flow tables, and the processor is configured to perform the following operations:
obtaining identification information of the flow table that matches the packet to be forwarded;
obtaining an address of a corresponding bucket in the second memory according to the identification information;
obtaining the keyword and the data of the flow table stored in the bucket; and
performing the forwarding processing on the packet to be forwarded according to the data of the flow table in the case that the keyword of the flow table matches the keyword of the packet to be forwarded.
